(19) United States
(12) Patent Application Publication
(10) Pub. No.: US 2007/0199953 A1
(43) Pub. Date: Aug. 30, 2007

(54) Dispensing container for two flowable products

(76) Inventors: Richard A. Laveault, Ft. Wayne, IN (US); Brian R. Law, Leicester (GB); Stephen E. Stalions, Ft. Wayne, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/362,938

(22) Filed: Feb. 27, 2006

(51) Int. Cl. B67D 5/56; A47G 19/14; B67D 3/00

(52) U.S. Cl. 222/129; 222/481; 222/465.1

(57) ABSTRACT

A dispensing container assembly for two flowable products according to the present invention includes a first container constructed and arranged for receiving a first flowable product and a second container positioned inside of the first container and being constructed and arranged for receiving a second flowable product. The two products are dispensed concurrently in a desired ratio. Each container includes a dispensing outlet with at least a portion of a dispensing closure being assembled to each outlet such that product from within the selected container is dispensed through that portion of the dispensing closure that is connected to that container outlet. The flow outlets are sized to create the desired mixing ratio for the two products.

### BACKGROUND OF THE INVENTION

The present invention relates in general to dispensing containers that include a container body, a closure connected into an outlet of the container body, and a closing cap assembled to the closure. More specifically, the present invention relates to a dispensing container assembly that is constructed and arranged to separately contain two flowable products in two separate containers wherein the configuration allows those two flowable products to be separately dispensed, concurrently. In this manner, the two flowable products are allowed to mix only after being dispensed (i.e., co-dispensing) into or onto a receiving receptacle or surface. Structural features and relationships disclosed by various embodiments of the present invention enable the two flowable products to be co-dispensed in a particular (predetermined) mix ratio. Some of the needs for this type of proportionate dispensing are described in U.S. Pat. No. 4,678,103, issued Jul. 7, 1987 to Dirksing.

As stated in the '103 patent, many chemical systems require two or more components to be kept separate before they are mixed and used in order to achieve certain desired properties. Such systems include epoxy adhesives, detergent and bleach combinations, detergent and fabric softener combinations, beverages, and foodstuffs, to list some of the possibilities. In such systems, it is usually important for the relative proportions of the two components to remain within certain limits to achieve optimal results. In the preferred embodiment, though the use of the invention is not limited to this preferred embodiment, the two products are a clear coat material and a lacquer thinner. These two products need to be mixed in order to achieve the desired viscosity for use in a spray paint gun or equipment.

When different amounts of such multi-component systems are needed, it has been generally necessary to first weigh-measure or volume-measure the components separately and then mix them by hand. In addition to being time consuming and messy, such systems are impractical because weighing or measuring devices are typically not available at the place where such multi-component systems are to be applied. Few households, for example, have measuring devices that permit proper proportioning of components in small quantities, and estimating proportions by eye is not only difficult, but risks failure in achieving the proper proportions and the corresponding optimal characteristics of the chemical system.

Related benefits of the disclosed embodiment of the present invention include the ability to provide everything in a single package and the elimination of any particular skill level to be able to measure out the two products in the right ratio. From a marketing perspective, the two-product combination in a single package ensures that both products will be purchased from the same manufacturer. When one of the two products is a common composition and not proprietary, it could be obtained from other sources, but for this two-product, pre-packaged combination.

There have been many attempts to provide plural-chambered dispensing devices that co-dispense two or more flowable products. However, in trying to maintain a constant pouring or dispensing ratio between the poured products, most of these devices require complex and expensive features which make the devices difficult and impractical to manufacture. In addition, the particular structures of these devices usually do not provide the degree of metering accuracy necessary for certain co-dispensing products and the applications for those products.

The '103 patent elected to address this design challenge by first placing an inner container within an outer container for the two flowable products and then placing a third, empty container inside of the inner container. The intent was to try and use the empty container to affect the pouring characteristics of the inner container in the same way that the inner container would presumably affect the pouring characteristics of the outer container.

In addition to the obvious inefficiencies of fabricating and installing a third, empty container, its size causes an increase in the overall size of the inner container and/or a reduction of the volume of product that can be contained therein. As the inner container increases in size, so as to handle the desired volume of product, the outer container must correspondingly increase in size.

With regard to the invention embodiments disclosed herein, in two of the embodiments, a fitment member is a unitary, molded plastic component that is constructed and arranged into two side-by-side portions. This unitary fitment serves as a part of the dispensing structure for both products. In one embodiment of the disclosed invention, two separate fitments are used, one for each flowable product. In two other embodiments, as disclosed herein, the fitment is a unitary component constructed and arranged into inner and outer portions with the inner portion serving the inner container and the outer portion serving the larger, outer container.

### BRIEF SUMMARY OF THE INVENTION

A dispensing container assembly for two flowable products according to the present invention includes a first container constructed and arranged for receiving a first flowable product and a second container positioned inside of the first container and being constructed and arranged for receiving a second flowable product. Each container includes a dispensing outlet with at least a portion of a dispensing closure assembled to that outlet such that product from within the selected container is dispensed through that portion of the dispensing closure that is connected to that container outlet. Various embodiments are disclosed and include dispensing closures in side-by-side relationship, as well as a single dispensing closure where the dispensing flows are generally concentric. Other features include dispensing spouts, partitions to maintain separate and independent flows, and venting arrangements for smooth and continuous dispensing.

One object of the present invention is to provide an improved dispensing container assembly for two flowable products.

Related objects and advantages of the present invention will be apparent from the following description.

### BRIEF DESCRIPTION OF THE SEVERAL VIEWS OF THE DRAWINGS

FIG. 1 is a perspective view of a dispensing container assembly according to a typical embodiment of the present invention.

FIG. 2 is a top plan view of the FIG. 1 dispensing container assembly.

FIG. 3 is a side elevational view of the FIG. 1 dispensing container assembly.

FIG. 4 is an end elevational view of the FIG. 1 dispensing container assembly.

FIG. 5 is an end elevational view, in fill section, of the FIG. 1 dispensing container assembly.

FIG. 6 is a side elevational view, in full section, of the FIG. 1 dispensing container assembly.

FIG. 7 is an exploded view of the FIG. 1 dispensing container assembly.

FIG. 8 is a front elevational view, in full section, of a fitment comprising one portion of the FIG. 1 dispensing container assembly.

FIG. 9 is a front elevational view, in full section, of an adapter sleeve comprising one portion of the FIG. 1 dispensing container assembly.

FIG. 10 is a front elevational view, in full section, of a dispensing spout comprising one portion of the FIG. 1 dispensing container assembly.

FIG. 11 is a side elevational view, in full section, of the FIG. 10 dispensing spout.

FIG. 12 is a front elevational view, in full section, of a closing cap comprising one portion of the FIG. 1 dispensing container assembly.

FIG. 13 is a perspective view of a dispensing container assembly according to another embodiment of the present invention.

FIG. 14 is an end elevational view of the FIG. 13 dispensing container assembly.

FIG. 15 is a side elevational view of the FIG. 13 dispensing container assembly.

FIG. 16 is a side elevational view, in full section, of the FIG. 13 dispensing container assembly.

FIG. 17 is an end elevational view, in full section, of the FIG. 13 dispensing container assembly.

FIG. 18 is an exploded view of the FIG. 13 dispensing container assembly.

FIG. 19 is a front elevational view, in full section, of a fitment comprising a portion of the FIG. 13 dispensing container assembly.

FIG. 20 is a front elevational view, in full section, of a second fitment comprising a portion of the FIG. 13 dispensing container assembly.

FIG. 21 is a front elevational view, in full section, of an adapter sleeve comprising a portion of the FIG. 13 dispensing container assembly.

FIG. 22 is a front elevational view, in full section, of a closing cap comprising a portion of the FIG. 13 dispensing container assembly.

FIG. 23 is a perspective view of a dispensing container assembly according to another embodiment of the present invention.

FIG. 24 is a top plan view of the FIG. 23 dispensing container assembly.

FIG. 25 is a side elevational view of the FIG. 23 dispensing container assembly.

FIG. 26 is an end elevational view, in full section, of the FIG. 23 dispensing container assembly.

FIG. 27 is an end elevational view, in full section, of the FIG. 23 dispensing container assembly.

FIG. 28 is a side elevational view, in full section, of the FIG. 23 dispensing container assembly.

FIG. 29 is an exploded view of the FIG. 23 dispensing container assembly.

FIG. 30 is a front elevational view, in full section, of a fitment comprising one portion of the FIG. 23 dispensing container assembly.

FIG. 31 is a side elevational view, in full section, of the FIG. 30 fitment.

FIG. 32 is a front elevational view, in full section, of an adapter sleeve comprising a portion of the FIG. 23 dispensing container assembly.

FIG. 33 is a front elevational view, in full section, of closing cap comprising a portion of the FIG. 23 dispensing container assembly.

FIG. 34 is a perspective view of a dispensing container assembly according to another embodiment of the present invention.

FIG. 35 is a side elevational view of the FIG. 34 dispensing container assembly.

FIG. 36 is an end elevational view of the FIG. 34 dispensing container assembly.

FIG. 37 is an end elevational view, in full section, of the FIG. 34 dispensing container assembly.

FIG. 38 is a side elevational view, in full section, of the FIG. 34 dispensing container assembly.

FIG. 39 is an exploded view of the FIG. 34 dispensing container assembly.

FIG. 40 is a front elevational view, in full section, of a fitment comprising one portion of the FIG. 34 dispensing container assembly.

FIG. 41 is a side elevational view, in full section, of the FIG. 40 fitment, with vent tubes attached.

FIG. 42 is a front elevational view, in full section, of an adapter sleeve comprising one portion of the FIG. 34 dispensing container assembly.

FIG. 43 is a front elevational view, in full section, of a closing cap comprising one portion of the FIG. 34 dispensing container assembly.

FIG. 44 is a perspective view of a dispensing container assembly according to another embodiment of the present invention.

FIG. 45 is a side elevational view of the FIG. 44 dispensing container assembly.

FIG. 46 is an end elevational view of the FIG. 44 dispensing container assembly.

FIG. 47 is an end elevational view, in full section, of the FIG. 44 dispensing container assembly.

FIG. 48 is a side elevational view, in full section, of the FIG. 44 dispensing container assembly.

FIG. 49 is an exploded view of the FIG. 44 dispensing container assembly.

FIG. 50 is a front elevational view, in full section, of a fitment comprising one portion of the FIG. 44 dispensing container assembly.

FIG. 51 is a side elevational view, in full section, of the FIG. 50 fitment.

FIG. 52 is a front elevational view, in full section, of a closing plug comprising one portion of the FIG. 44 dispensing container assembly.

FIG. 53 is a side elevational view, in full section, of the FIG. 52 closing plug.

FIG. 54 is a front elevational view, in full section, of a closing cap comprising one portion of the FIG. 44 dispensing container assembly.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The various embodiments of the present invention each pertain to a dispensing container assembly for two flowable products (product A and product B). In terms of the construction of these embodiments and the terminology used herein, the dispensing container assembly includes an outer, larger capacity container that holds one of the two flowable products and also receives, within its interior, a smaller container, referred to herein as the “inner” container. This inner, smaller container holds the other product. These various embodiments are related in that each one includes at least one fitment that attaches to the outer, larger container and/or to the inner, smaller container. The fitment may be a single component or two separate fitments may be used. Each embodiment also includes some combination or arrangement of an adapter sleeve and dispensing spout or dispensing outlet. The adapter sleeve and the dispensing spout may be unitary or integral or may be separate components. Finally, each embodiment includes at least one threaded closing cap.

A further structural feature of each embodiment disclosed herein is that the dispensing arrangement for each flowable product has a selected flow area that is designed to govern and control the dispensing rate of the corresponding flowable product. Further, there is a preselected and predetermined flow ratio for the two products that is controlled by the selected flow area of one dispensing arrangement and the selected flow area of the other dispensing arrangement. This allows the two products (products A and B) to be concurrently dispensed as two separate flows, but dispensed in the desired mix ratio, such as 2:1, and mixed together in this ratio only after being dispensed into the receiving (mixing) receptacle or onto the receiving surface. This controlled and predetermined dispensing ratio feature is present in each of the various embodiments disclosed herein.

Being filed concurrently with this application are two commonly-owned applications disclosing dispensing containers for two flowable products. Due to similarities in their subject matter, these two applications are incorporated by reference into this application. One application is identified by client reference RKE-105 and by the attorney matter number 1104-944 and is entitled DISPENSING CONTAINER FOR TWO FLOWABLE PRODUCTS. The other application being incorporated by reference herein is identified by client reference RKE-106 and by attorney matter number 1104-956 and is entitled DISPENSING CONTAINER FOR TWO FLOWABLE PRODUCTS.

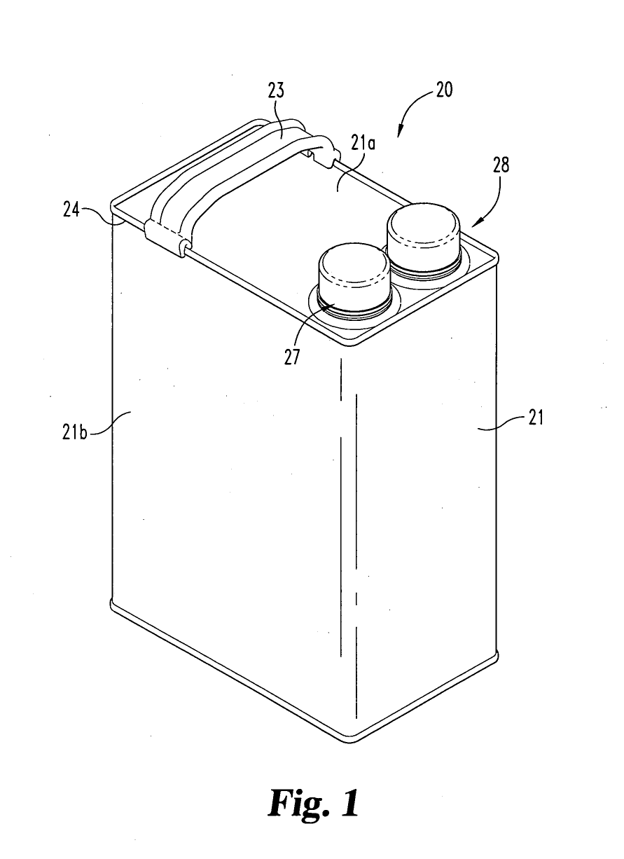

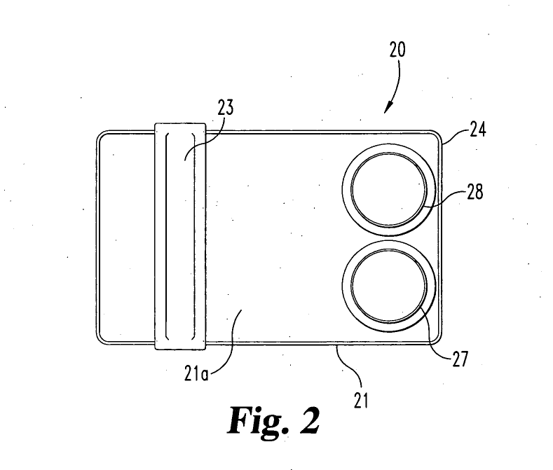

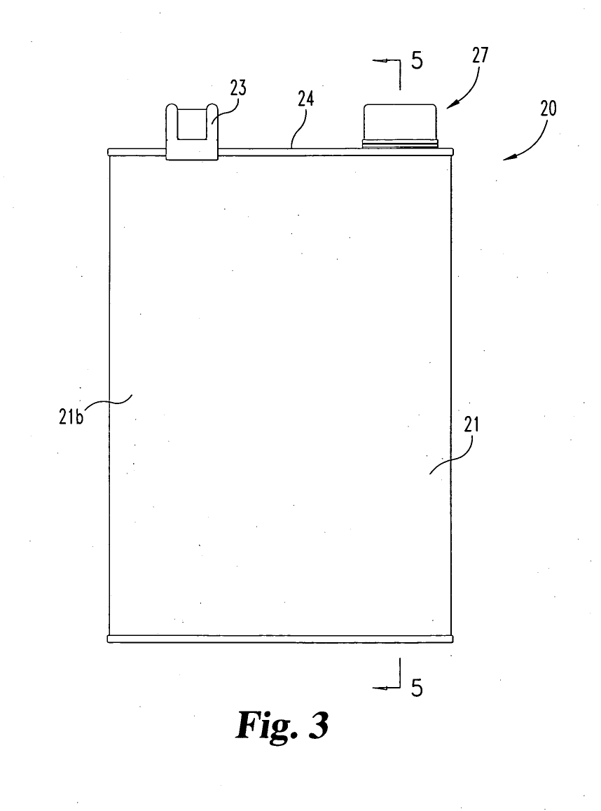

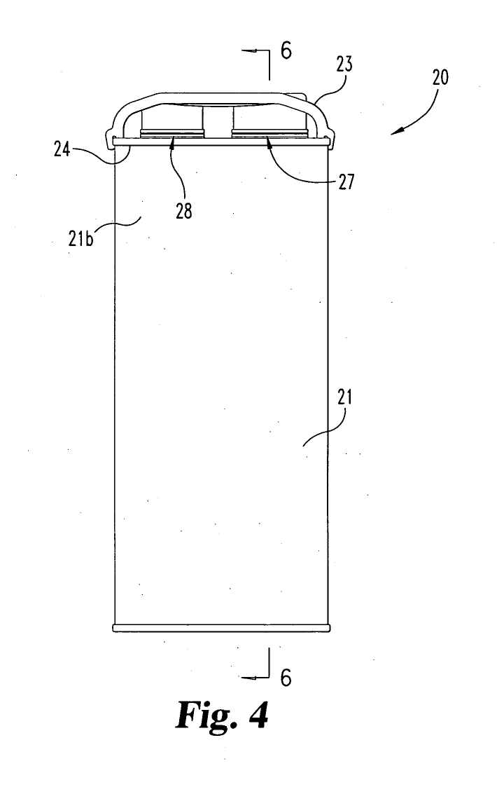

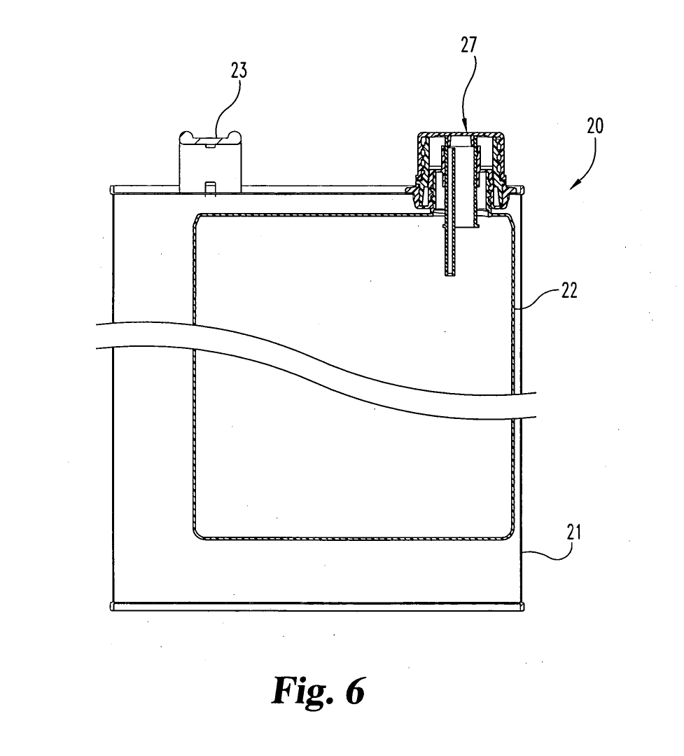

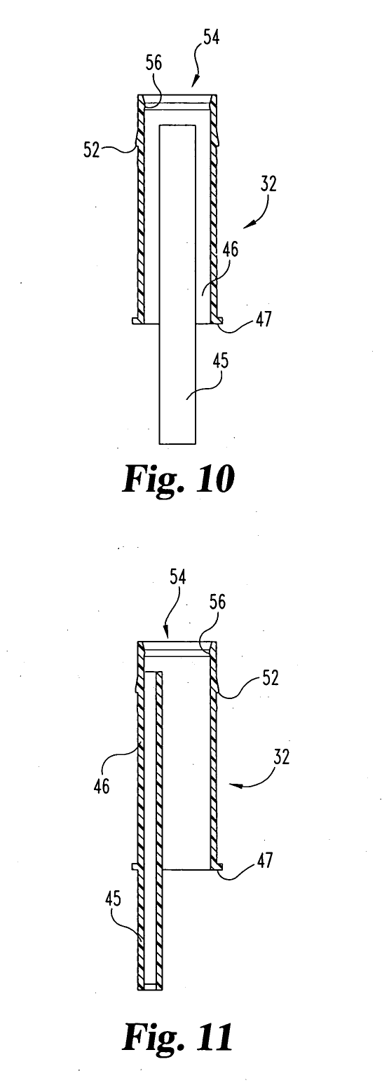

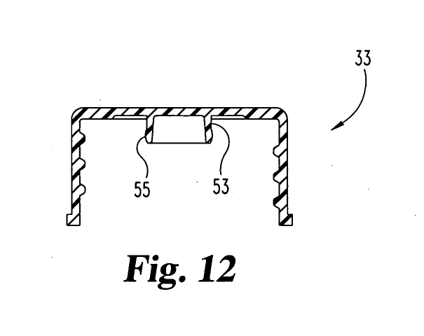

Referring first to FIGS. 1-12, a first embodiment of the present invention is illustrated. While reference will be made to dispensing container 20, it will be understood that this structure is in fact an assembly of outer, larger container 21 and inner, smaller container 22 and a number of cooperating component parts that help to define the dispensing closure structure. The inner, smaller container 22 can be configured as a collapsible container, as a flexible bag, or as a flexible pouch. It should also be noted that this inner, smaller container 22 can be configured as a more rigid structure and would include a thin-walled blow-molded plastic structure. The various illustrations of the inner container 22, and the inner containers of the other embodiments, are not intended to be limiting in terms of whether the container is rigid or flexible or anything in between.

Preferably, container 21 is a metal can with a generally rectangular solid form and while container 22 is preferably plastic, other materials are contemplated so long as they product the desired flexibility or rigidity. If container 22 has sufficient flexibility and collapsibility, it may be possible to collapse and compress it to a degree to insert it into container 21 by way of one of the two fitment openings in container 21. If container 22 is not sufficiently flexible for this assembly technique, then upper panel 21a is not seamed to container body 21 b until after container 22 is inserted into container 21 and connected to the dispensing closure as needed, based on the particular construction. Handle 23 is a plastic, snap-on structure that securely snaps onto the rolled seam or lip 24 that results from seaming upper panel 21a to container body 21b.

In this first embodiment, there are two separate and distinct dispensing closures 27 and 28 that are assembled into upper panel 21a. The construction of closures 27 and 28 are similar with dispensing closure 27 being flow coupled to container 22 for dispensing product B. Dispensing closure 28 is flow coupled to container 21 for dispensing product A. In terms of the product dispensing flow areas, dispensing closure 27 is constructed and arranged to dispense its product B at one-half the rate at which product A is dispensed by way of its dispensing closure 28. This 2:1 ratio of product A to product B is achieved by the flow area sizing of dispensing closures 27 and 28. It should be understood that these flow area sizes can be changed very easily by simply resizing the molds for the controlling parts or otherwise simply changing the dimensions. This then enables virtually any mix ratio of product A to product B to be achieved.

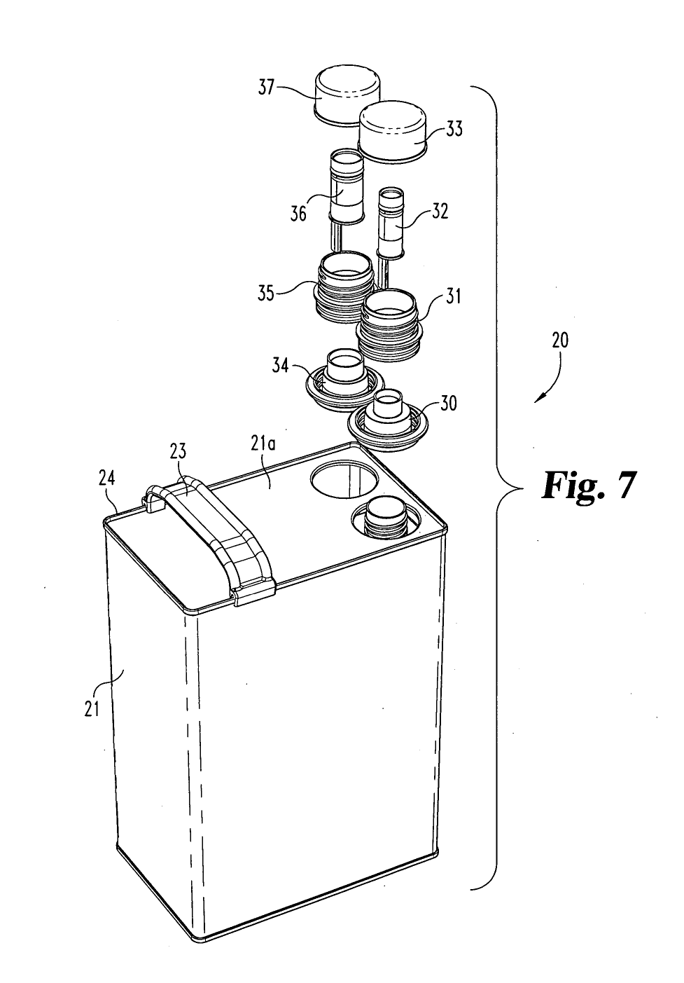

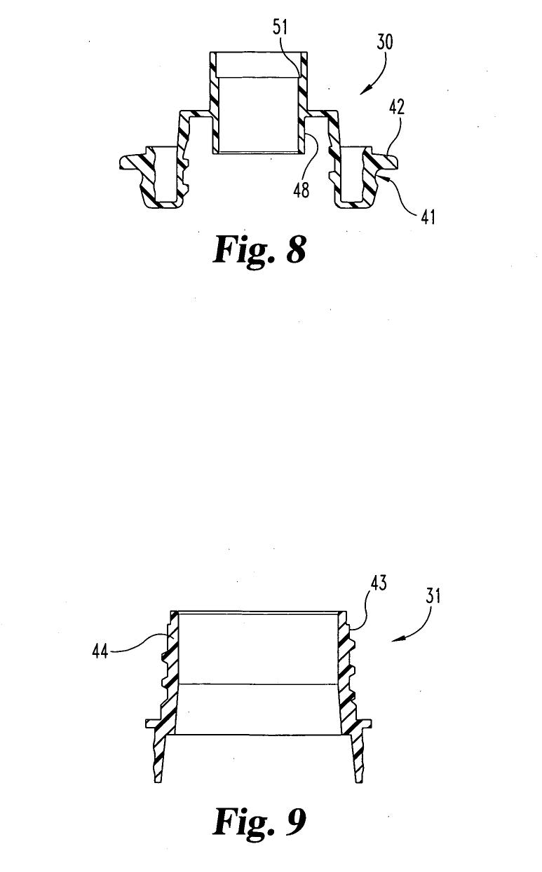

Considering FIG. 7, it will be seen that dispensing closure 27 includes a fitment 30, adapter sleeve 31, dispensing spout 32, and closing cap 33. Dispensing closure 28 includes the same type and grouping of components, only some are smaller and some portions are larger, such as the inside diameter size of the dispensing spout. These corresponding components of dispensing closure 28 include fitment 34, adapter sleeve 35, dispensing spout 36, and closing cap 37. While both dispensing closures 27 and 28 are illustrated in FIGS. 1-7, the individual part drawings (FIGS. 8-12) cover the component parts of dispensing closure 27. It should be understood that the individual part drawings for the component parts of dispensing closure 28 are (would be) quite similar. Perhaps the most significant structural difference, other than the different sizes for the referenced 2:1 mix ratio, is that the smaller container fitment 30 is internally-threaded for threaded connection to the externally-threaded neck of container 22.

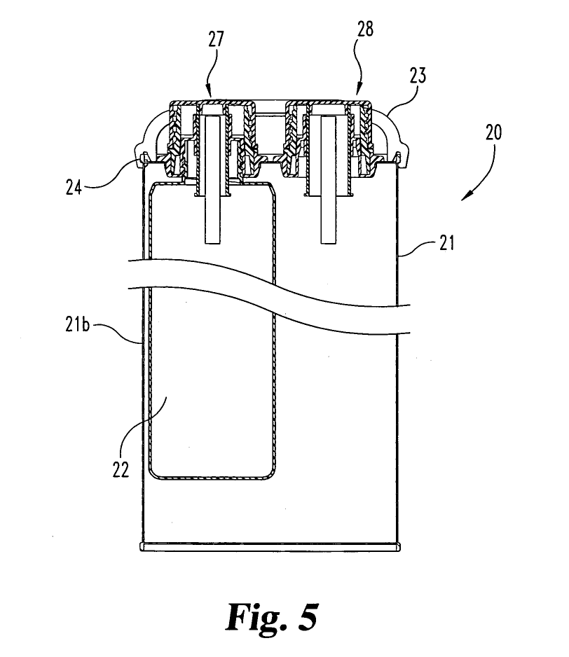

Referring now to FIGS. 5, 6, and 7, the interfit, relative positioning, and assembly of the four component parts that comprise each dispensing closure are illustrated. The annular, unitary, molded plastic fitments 30 and 34 are constructed and arranged to snap into circular openings in upper panel 21a. The shaping of the edge or lip of each opening and the cooperating channel or groove 41 below radial flange 42 enables a push-in (snap-fit) assembly with a resulting secure and tight fit. Adapter sleeves 31 and 35 connect to their corresponding fitments by a rib and groove pattern, allowing a push together (axial) manner of assembly. This adapter sleeve is required for each of the two fitments in order to simplify what would otherwise be a very complex overall part. Molding the fitment and adapter sleeve subassembly as two separate component parts is a less complicated and less costly approach as compared to trying to create that subassembly as one molded part. While the details of dispensing closure 27 are described hereinafter, it is to be understood that virtually the same structures exist in dispensing closure 28 and generally the same description would be applicable.

The outer surface 43 of the upper portion 44 of the adapter sleeve 31 is threaded for threaded engagement with the corresponding closing cap 33. As noted, a similar structure exists for dispensing closure 28 that would include adapter sleeve 35 and closing cap 37. The unitary, molded plastic dispensing spout 32 includes a vent tube 45 that is part of one sidewall 46 and extends below the lower edge 47 of the corresponding dispensing spout 32. The fitment 30 includes an inner sleeve 48 that receives and supports its corresponding dispensing spout. The sleeve 48 includes an annular ledge 51 that provides a type of support shelf upon which the outer rib 52 of the dispensing spout rests. This abutment or support of the dispensing spout by its respective fitment sleeve prevents the spout from moving axially downwardly. The closing cap 33 includes an annular inner sleeve 53 that plugs into the upper, open end 54 of the respective dispensing spout 32.

The inner sleeve 53 includes a raised annular rib 55 that snaps in below the internal rib 56 formed on the inside diameter of the dispensing spout 32. This cooperating construction enables the closing cap to close off the dispensing spout and to raise the spout (axially) automatically as the closing cap is unscrewed from the adapter sleeve. A snug friction fit between the dispensing spout outside diameter and the inside diameter of the inner sleeve of the corresponding fitment is established. This causes the dispensing spout to retain its extended position resulting from closing cap removal. The closing cap is then separated from its dispensing spout for enabling the dispensing of product. The extended dispensing spouts help to keep product A and product B separate from each other until these two flowable products reach the mixing receptacle or mixing location. Reversing the sequence of “opening” steps restores the assembly to what is illustrated in FIG. 5.

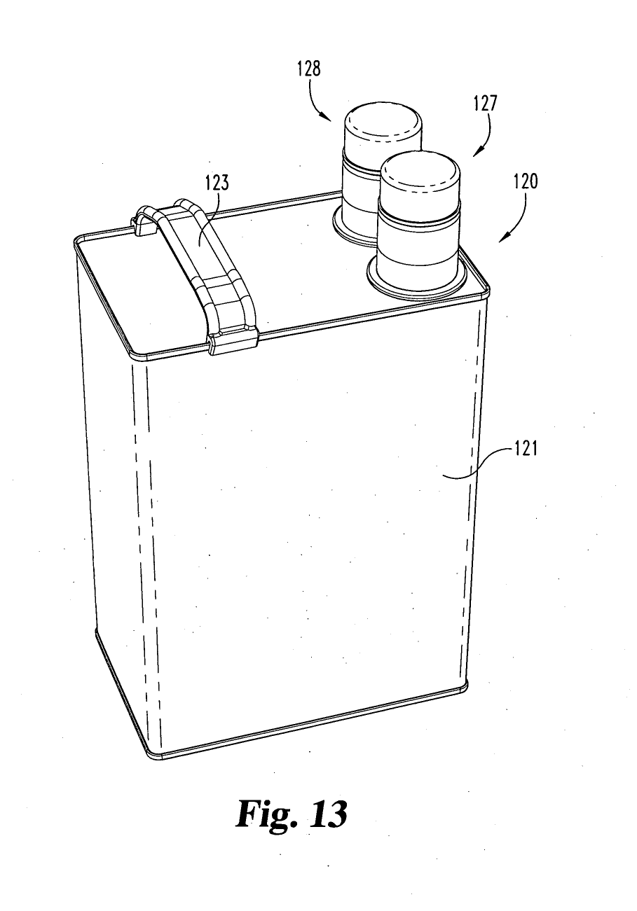

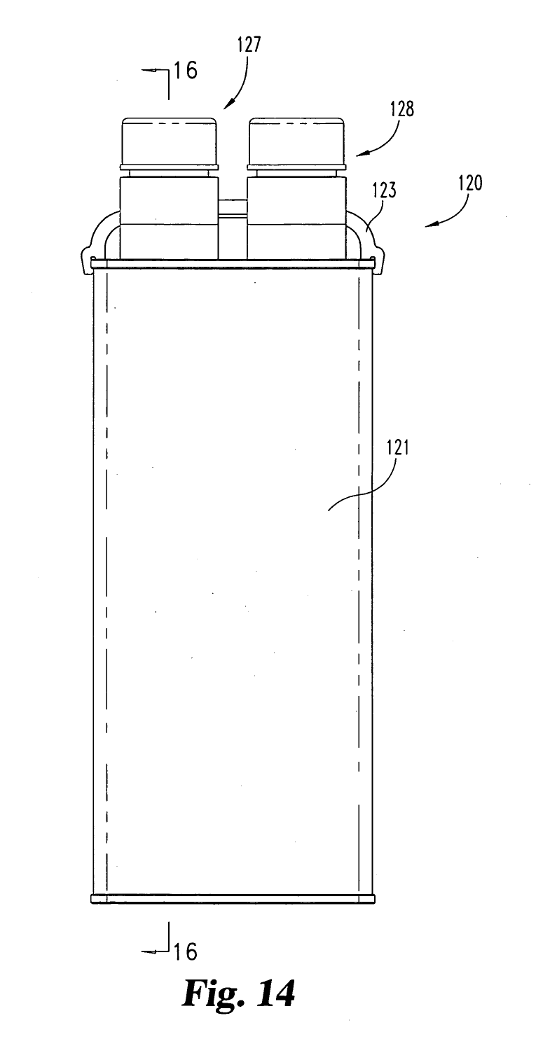

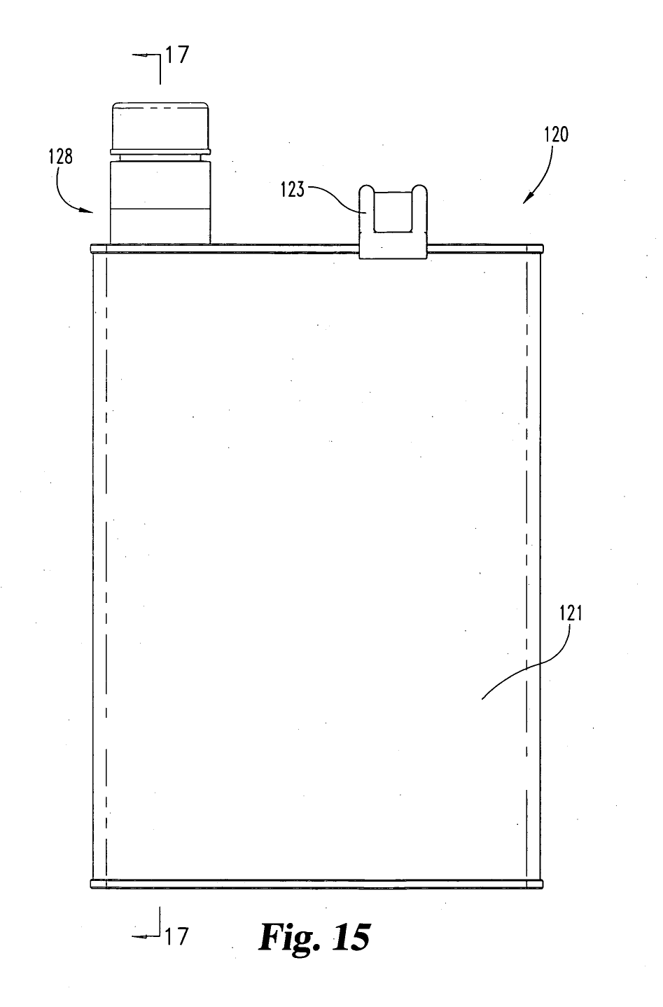

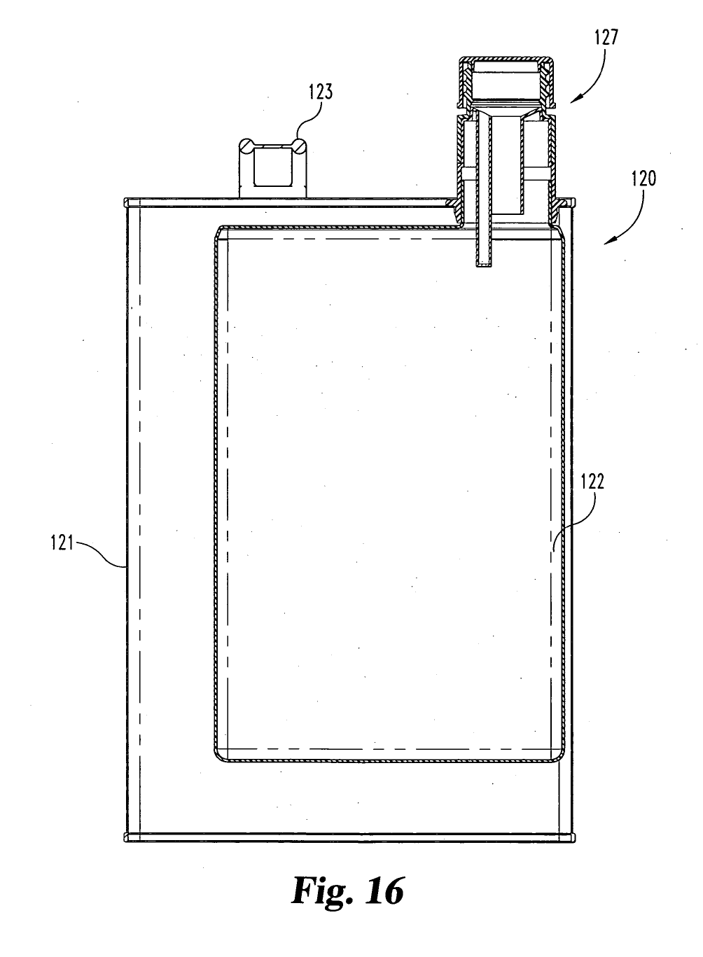

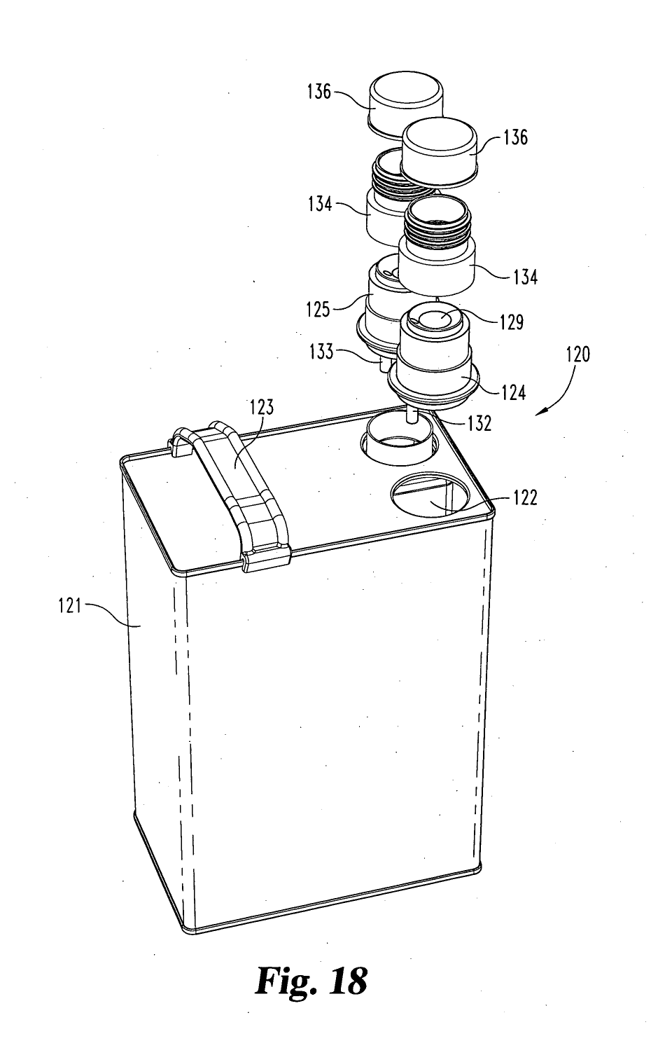

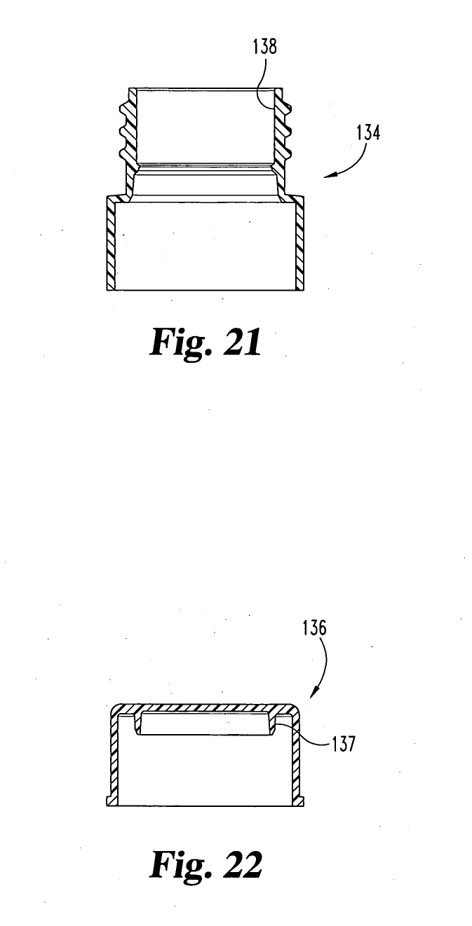

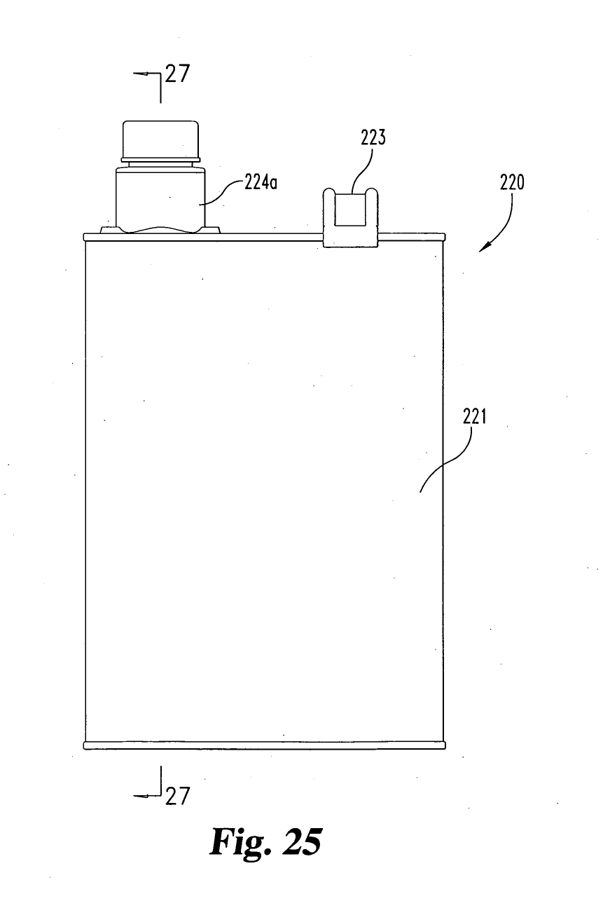

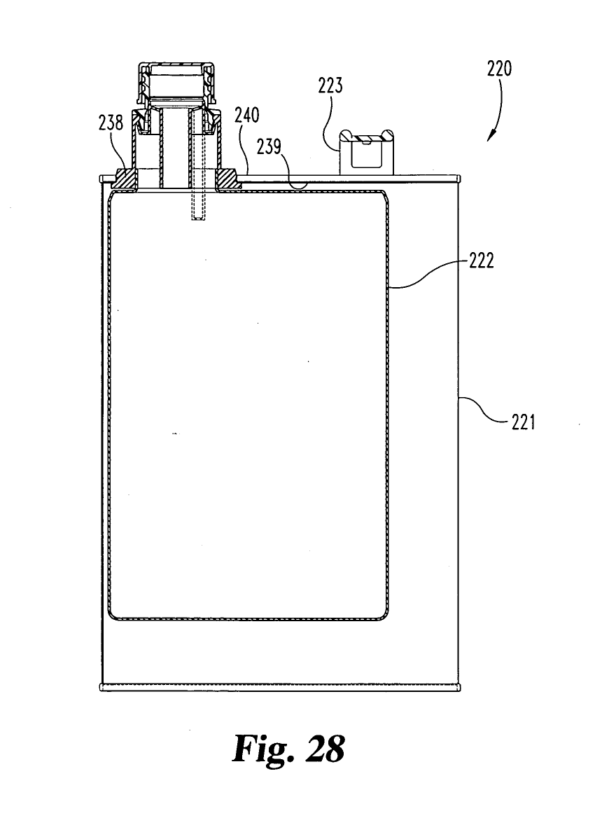

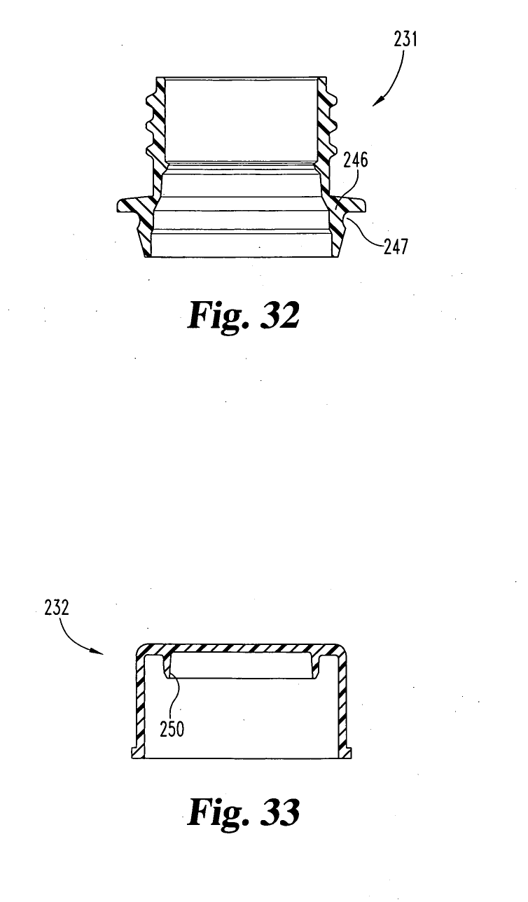

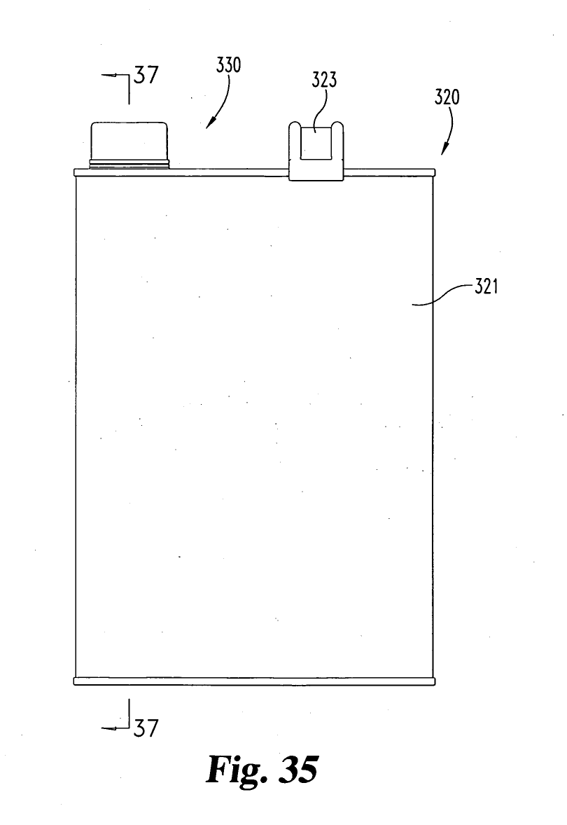

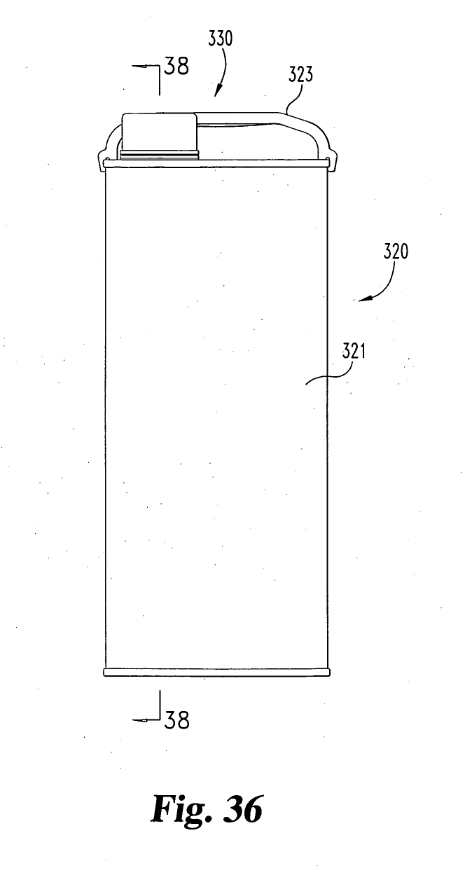

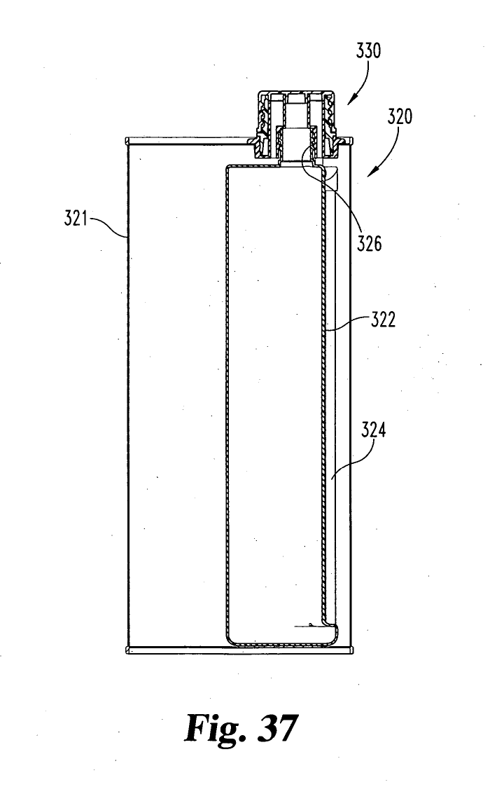

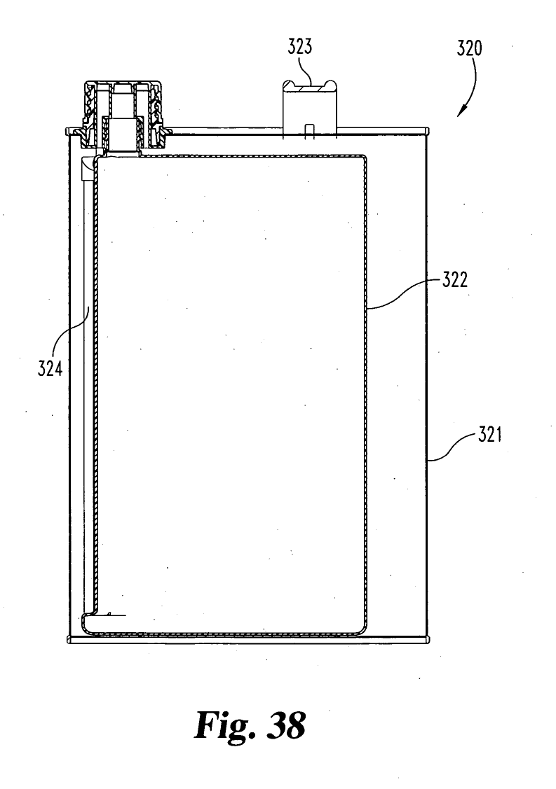

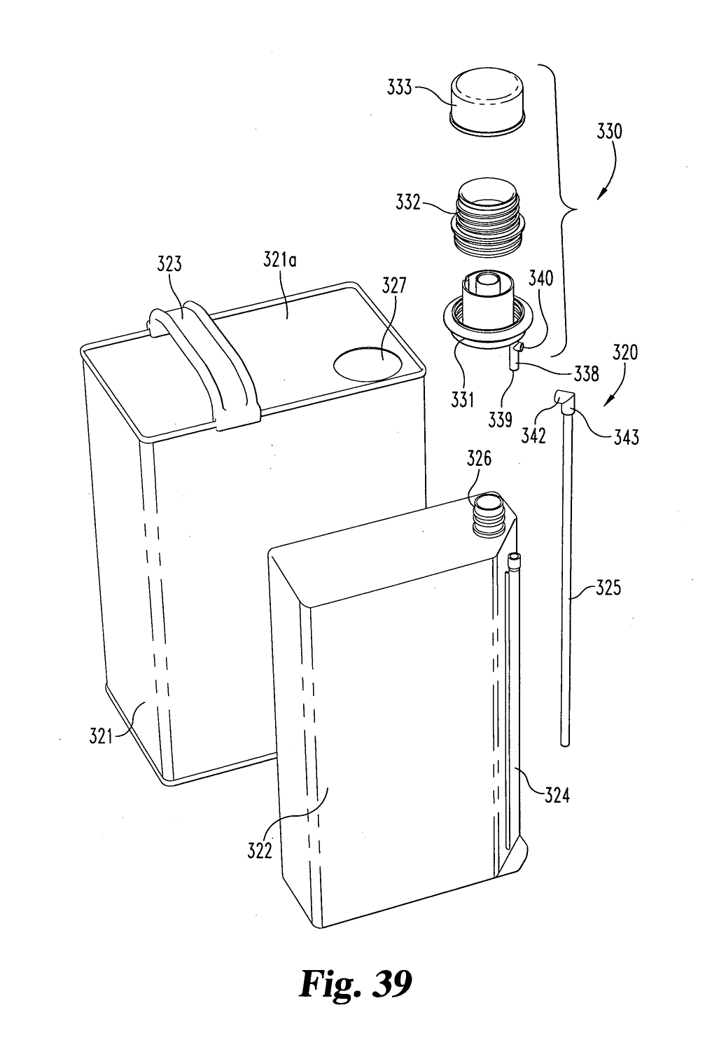

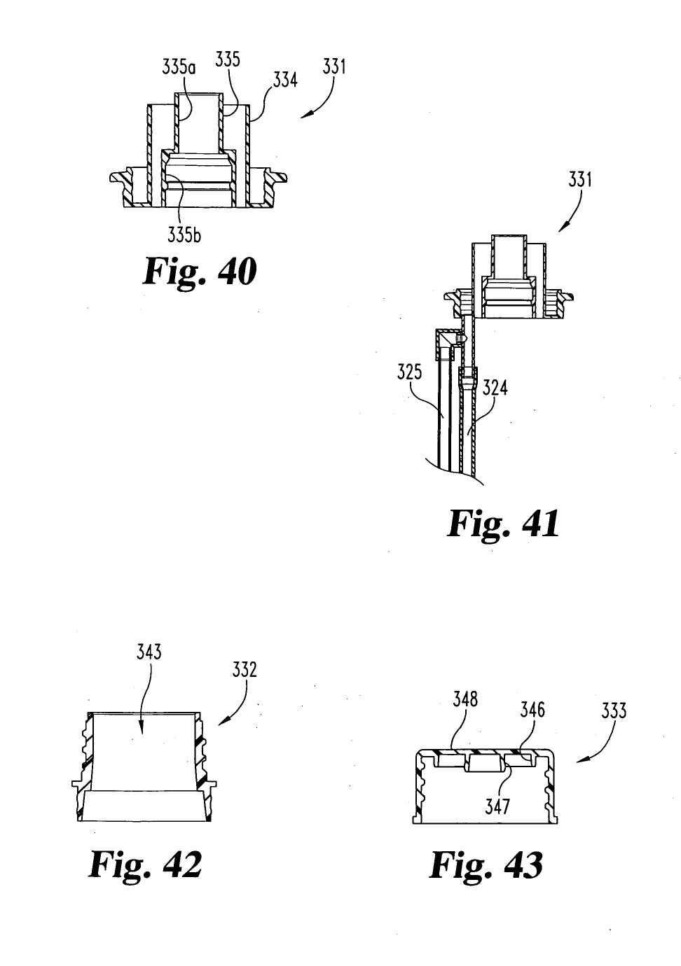

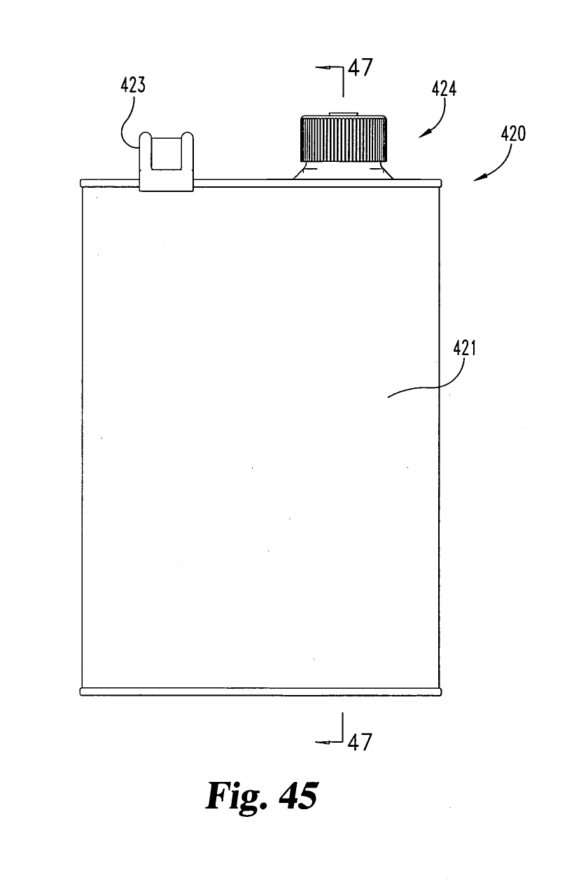

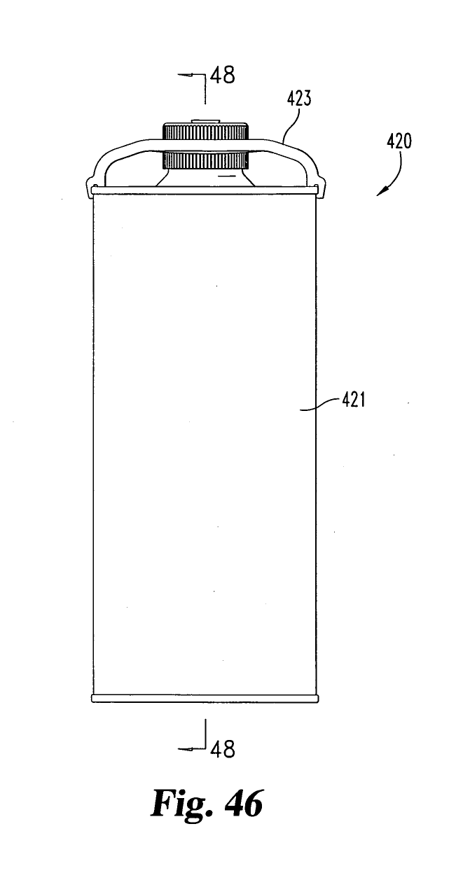

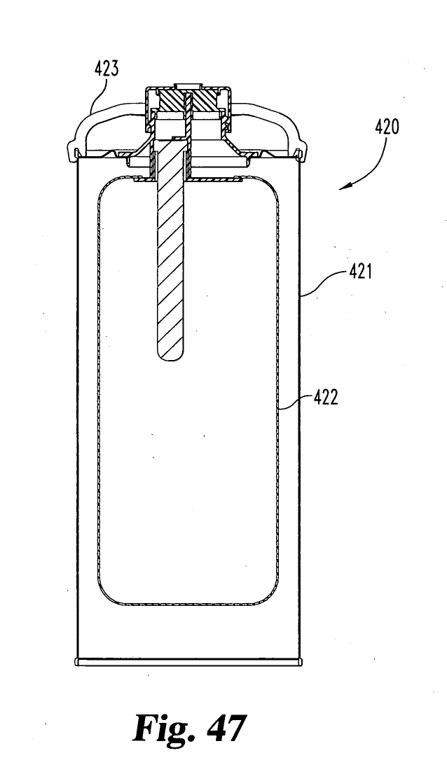

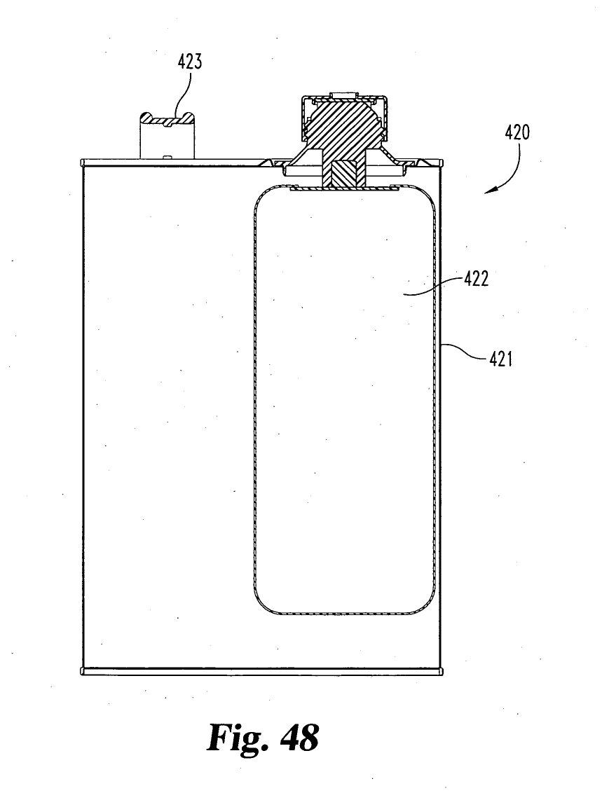

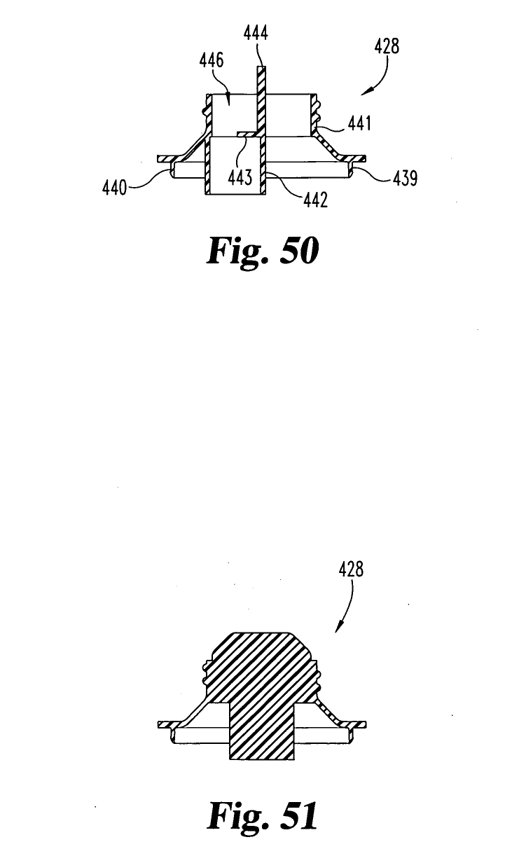

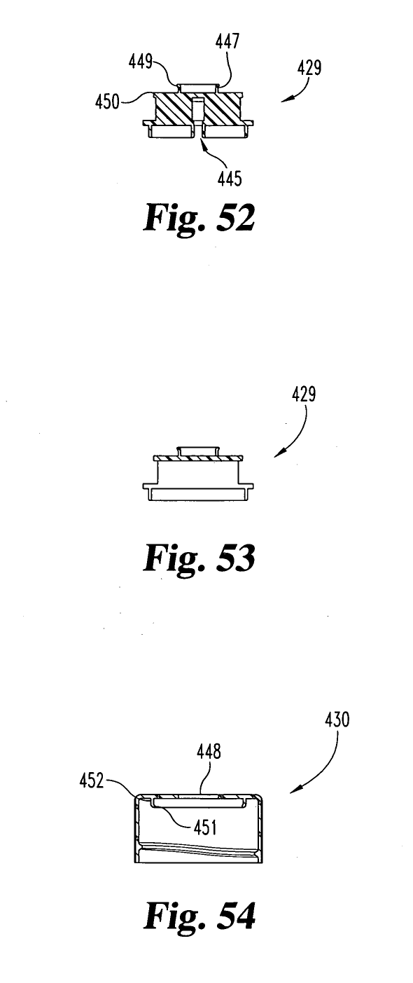

It is important to note that many of the component shapes, structures, and relationships described and illustrated with respect to FIGS. 1-12, and in fact with respect to FIGS. 13-54, are similar to some and may be virtually identical to others of what is disclosed in the two references that are incorporated by reference herein. These other two references employ some similar structural concepts and relationships for the snap-in assembly of the fitment and the manner of connecting to and extending the dispensing spout.

Referring now to FIGS. 13-22, another dispensing container assembly embodiment of the present invention is illustrated. The construction of dispensing container (assembly) 120 is similar to dispensing container 20 in terms of container 121, container 122, and handle 123 as compared to the corresponding components of container 21, container 22, and handle 23 in the embodiment of FIGS. 1-12. A detailed description of these parts will not be repeated here due to their virtually identical form, fit, and function to those corresponding parts or portions of dispensing container 20. Additionally, while the fitments 124 and 125 are structurally different from fitments 30 and 34, the shape geometry of each fitment 124 and 125 that enables a secure and tight snap-in assembly remains virtually the same as that configured as part of fitments 30 and 34.

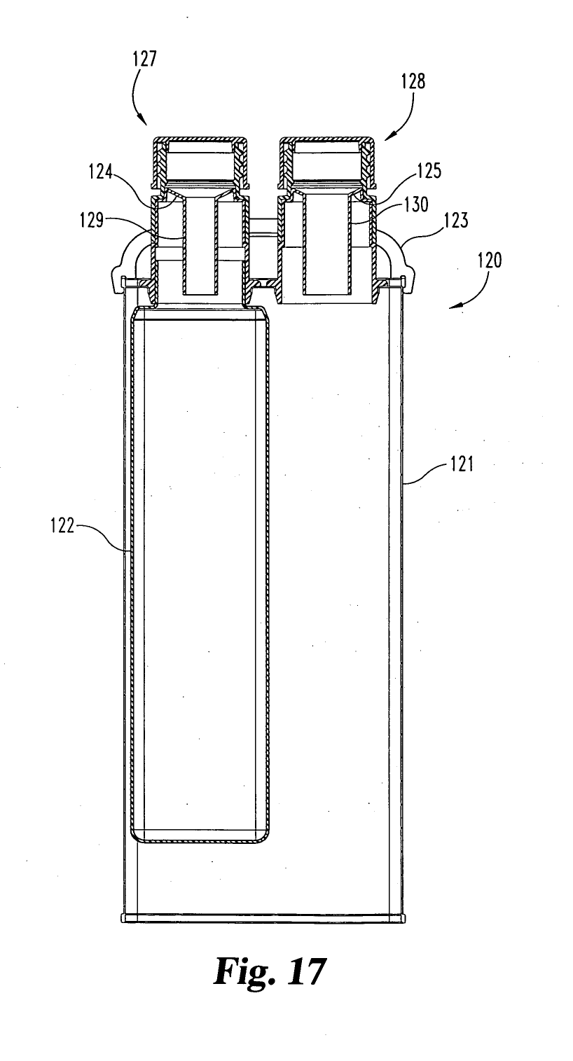

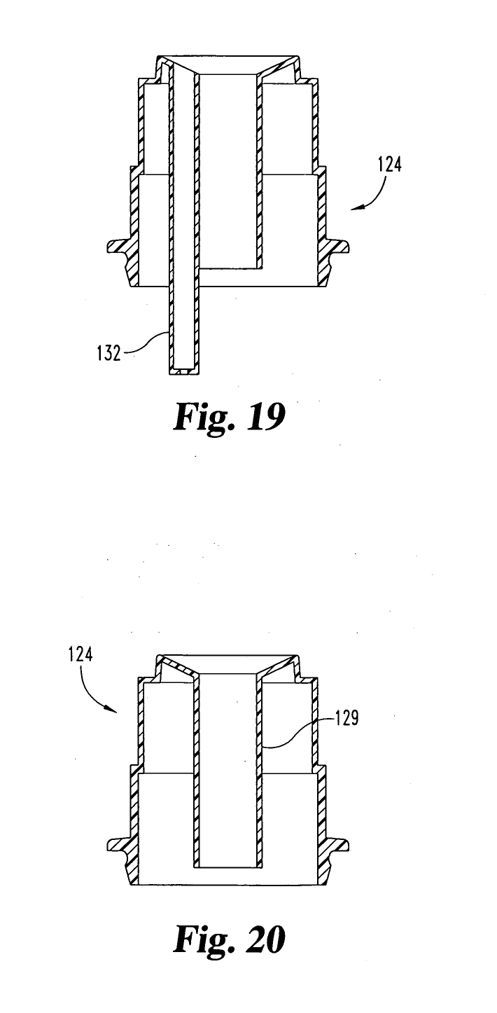

Dispensing closure 127 for product B from container 122 and dispensing closure 128 for product A from container 121 are identical except for the diameters of their interior spouts (see FIG. 17). As shown in FIGS. 19 and 20 in reference to unitary, molded plastic fitment 124 of dispensing closure 127, the dispensing spout 129 is a unitary portion of the molded fitment 124 and provides the flow path for product during dispensing. Similarly, the dispensing spout 130 of dispensing closure 128 is a unitary portion of fitment 125. The diameter size of each dispensing spout controls or establishes the flow area for the respective products and thus the mix ratio of the two flowable products. FIG. 17 provides a clear picture of the spout diameter differences for fitments 124 and 125. These respective size differences provide a product A to product B dispensing and mixing ratio of 2:1. As has been noted with other embodiments and with the two applications that are incorporated by reference, varying these flow area sizes allows one to selectively predetermine the desired mix ratio at virtually any ratio from 1:1 and higher.

Each fitment 124 and 125 includes a vent tube 132 and 133, respectively. Each dispensing closure 127 and 128 includes an adapter sleeve 134 and a closing cap 136. The adapter sleeve 134 and closing cap 136 of each dispensing closure have the same construction. The closing cap 136 threadedly engages the outside diameter threads of the corresponding adapter sleeve 134 and an interior cap wall 137 seals off and seals against the inside diameter surface 138 of the adapter sleeve 134. The adapter sleeve 134 and fitment 136 are press fit together into a tightly secured and sealed, integral subassembly. The nature of this assembly creates the cooperating structure illustrated in FIG. 17. Merely unscrewing the closing caps 136 permits products A and B to be dispensed concurrently in the desired and predetermined mixing ratio based upon the cross sectional flow areas of the dispensing spouts that are unitary portions of their respective fitments.

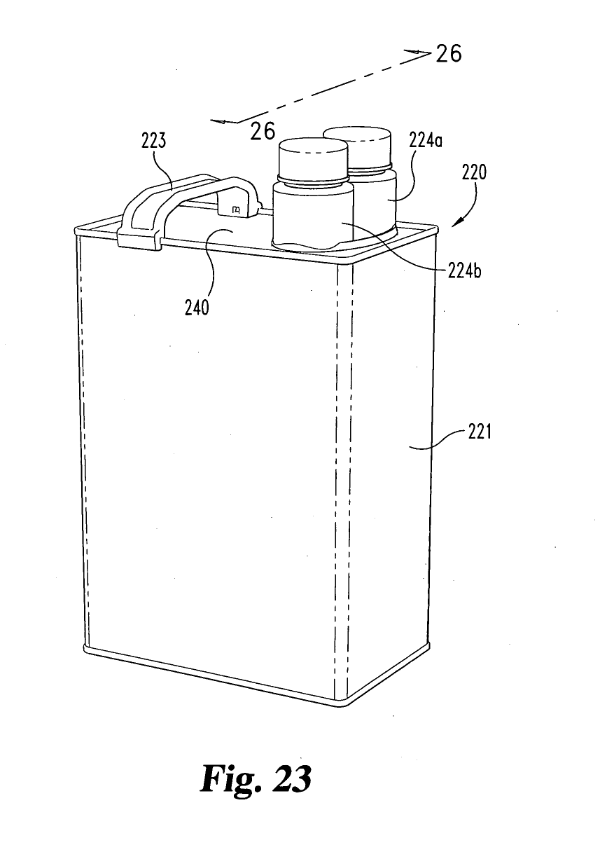

Referring now to FIGS. 23-33, another dispensing container embodiment of the present invention is illustrated. The construction of dispensing container 220 is similar to dispensing container 120 in terms of container 221, container 222, and handle 223 as compared to the corresponding components of container 121, container 122, and handle 123 in the embodiment of FIGS. 13-22. A detailed description of these parts will not be repeated here due to their virtually identical form, fit, and function to those parts of container 120. While other component parts of dispensing container 220 are very similar to the corresponding parts of dispensing container 120, the most notable difference is that dispensing container 220 includes a unitary, molded plastic, snap-in fitment module 224 that is constructed and arranged with two fitments 224a and 224b. Fitment 224a connects to outer container 221 and fitment 224b connects to inner container 222. The concurrent dispensing of products A and B is by way of fitments 224a and 224b, respectively.

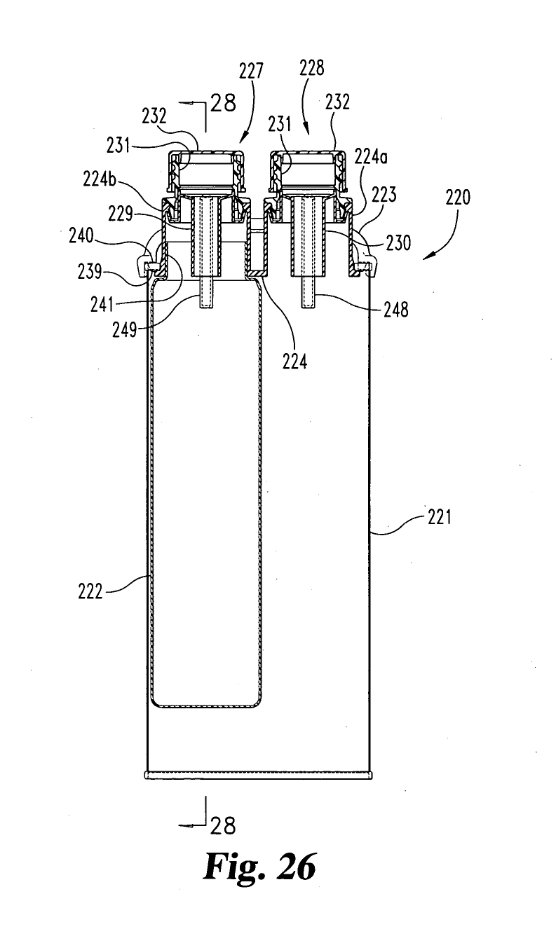

Dispensing closure 227 for product B from inner container 222 and dispensing closure 228 for product A are virtually identical to each other, except for the diameter size difference between their respective dispensing spouts 229 and 230, see FIG. 26. Dispensing closure 227 includes fitment 224b, dispensing spout 229, adapter sleeve 231, and closing cap 232. Dispensing closure 228 includes fitment 224a, dispensing spout 230, a second adapter sleeve 231, and a second closing cap 232. The structural similarities between fitment 224a and fitment 224b enable the use of the same adapter sleeve 231 and the same closing cap 232 for each dispensing closure 227 and 228.

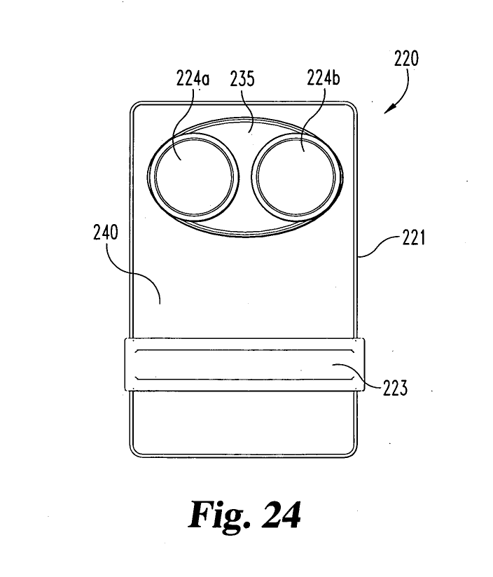

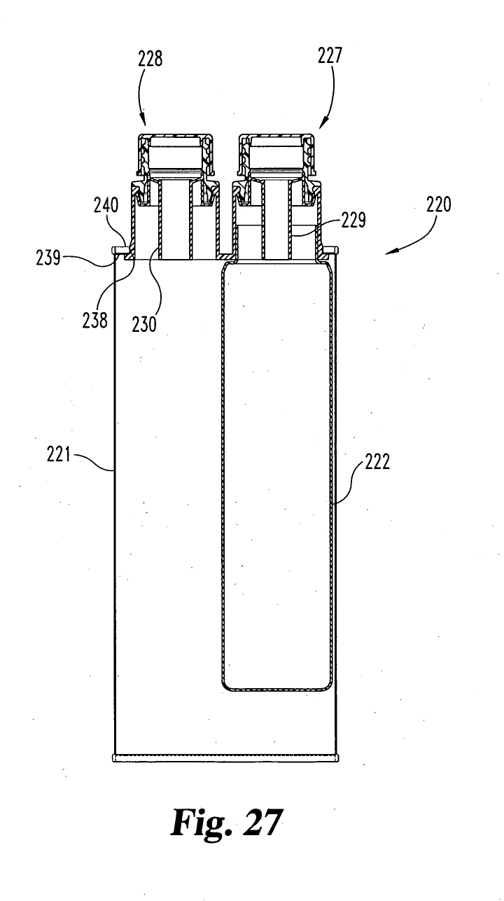

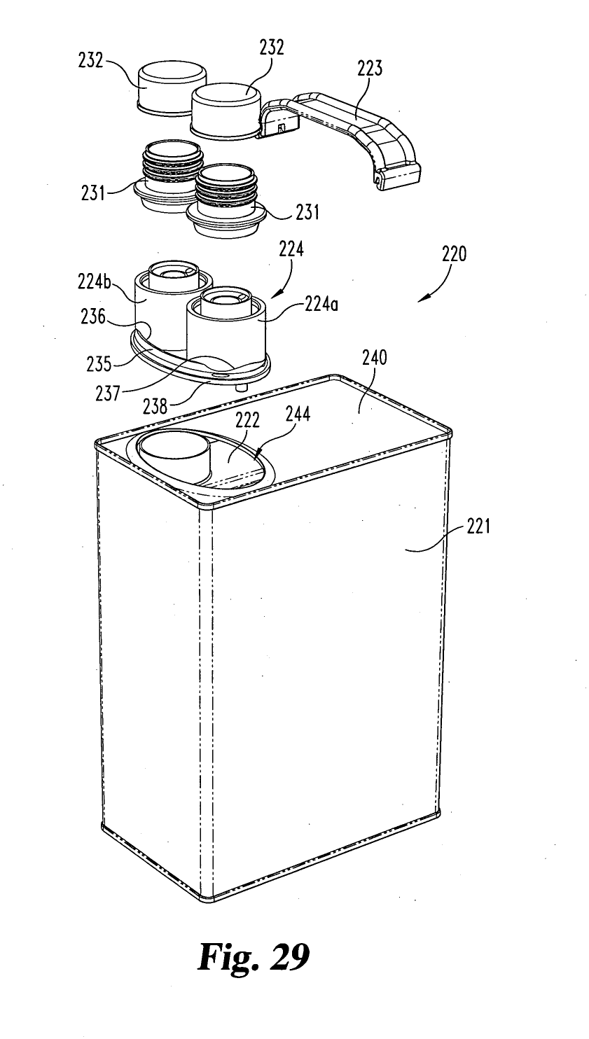

When combining the two fitments 224a and 224b into a unitary fitment module 224, the base 235 has an oval shape (see FIGS. 24 and 29). The base 235 includes a surrounding wall 236 with a contoured upper edge 237 and a lower radial flange 238. Fitments 124 and 125 (see FIG. 17) each include a radial flange and these flanges are seated against the upper surface of the top panel of the outer container 121. In contrast, radial flange 238 seats from the inside and is pressed up against the inner surface 239 of upper panel 240 of outer container 221. The portion of the fitment module 224 sidewall that is adjacent flange 238 is contoured to receive the edge of opening 244 defined by upper panel 240. As illustrated in FIG. 27, the inner container 222 includes a cylindrical neck 241 that is tightly press fit up into the inside diameter of fitment 224b.

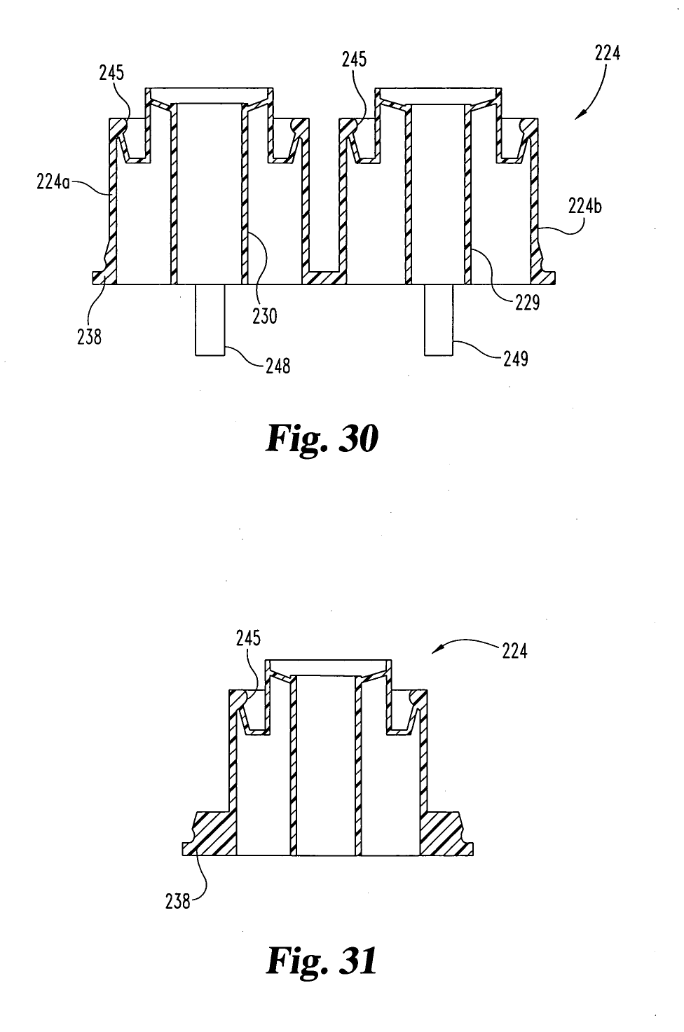

Referring to FIGS. 26 and 27, the assembly and connections of the component parts comprising each dispensing closure 227 and 228 are illustrated. With fitment 224 snapped into opening 244 of upper panel 240, the neck 241 is received by fitment 224b. Each adapter sleeve 231 snaps into its corresponding fitment. Each fitment 224a, 224b includes an annular, inwardly directed rib 245 (see FIGS. 30 and 31). The corresponding and cooperating adapter sleeves 231 include an annular, contoured portion 246 with an outwardly opening groove 247 that receives rib 245. Further, each fitment 224a, 224b includes a vent tube 248 and 249, respectively. Each internally-threaded closing cap 232 threads onto its corresponding externally-threaded adapter sleeve 231. Each closing cap includes an inner annular wall 250 that fits snugly into the inside diameter of the adapter sleeve so as to close off each dispensing closure 227 and 228. Merely unscrewing the closing caps 232 permits products A and B to be dispensed concurrently in the desired and predetermined mixing ratio based upon the cross sectional flow areas of the dispensing spouts 229 and 230.

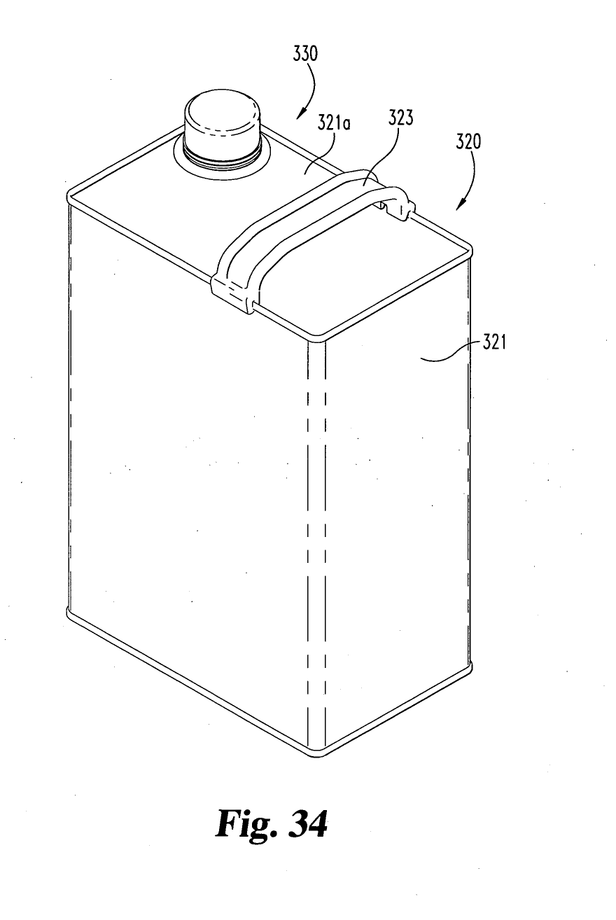

Referring now to FIGS. 34-43, another dispensing container embodiment of the present invention is illustrated. The construction of dispensing container (assembly) 320 is similar to dispensing containers 20, 120 and 220 in terms of the outer container 321 and handle 323. However, inner container 322 has a different structural configuration with the primary difference being the addition of vent tube 324. A second vent tube 325 is used in combination with vent tube 324 and provides venting air into container 321.

As is illustrated, inner container 322 fits within outer container 321 with the externally-threaded neck 326 of container 322 extending upwardly through the opening 327 defined by the upper panel 321a of outer container 321. A single dispensing closure 330 is used and is constructed and arranged to provide for the separate, but concurrent, flow of product A from the outer container 321 and product B from the inner container 322. Dispensing closure 330 includes fitment 331, adapter sleeve 332, and closing cap 333. The fitment 331 is constructed and arranged with an outer tubular sleeve 334 for product A and an inner tubular sleeve 335 for product B. The respective cross sectional flow areas of these two tubular sleeves 334 and 335, adjusted for the annular ring shape of the outer sleeve, are sized so as yield a dispensing and thus mixing ratio of 2 parts product A to one part product B. As has been previously noted, by changing the various sizes of the sleeves or spouts or fitments, as would be appropriate depending on the particular embodiment, the relative cross sectional flow areas can be changed to virtually any ratio which would then result in a different mixing ratio for the two flowable products. In the present embodiment, the two vent tubes 324 and 325 could be considered a part of the dispensing closure 330 in that these vent tubes enable a smooth and uninterrupted dispensing flow of products A and B. However, since vent tube 324 is integral with container 322 and opens into the interior of container 322 to let in air, the preferred approach is to not treat the vent tubes as part of dispensing closure 330. Further, if the vent tubes are not used, there will be a glugging action as to the products are being dispensed, but the dispensing closure 330 still functions in an acceptable manner.

Fitment 331 snaps into opening 327, similar to fitments 30 and 34, and adapter sleeve 332 snaps into fitment 331, similar to how adapter sleeve 31 snaps into and assembles with fitment 30. This subassembly of fitment 331 and adapter sleeve 332 is constructed and arranged such that these two component parts remain securely and tightly connected to each other and to container 321. The inner tubular sleeve 335 includes a smaller tubular portion 335a and a larger, internally-threaded portion 335b. Portion 335b threads onto the threaded neck 326 of inner container 322. The adapter sleeve 332 is externally threaded and the internally-threaded closing cap 333 threads onto the adapter sleeve to close off both of the dispensing flow passageways.

Fitment 331 includes a vent tube 338 as part of the unitary, molded plastic construction of fitment 331. Vent tube 338 is open at end 339 and includes a branch tube 340. Vent tube 338 tightly inserts into the upper, open, flared end 341 of vent tube 324. Branch tube 340 tightly inserts into the open end 342 of elbow 343 that is an integral portion of vent tube 325. This venting arrangement prevents “glugging” of the dispensing flow of products A and B and thereby allows the predetermined product mix ratio (based on respective flow outlet areas) to be maintained, uninterrupted.

The closing cap 333 is a unitary, molded plastic component that is constructed and arranged with an inner annular wall 346 and an intermediate annular wall 347 that is generally concentric with wall 346. Wall 346 depends from upper cap panel 348 and is configured to snugly insert into tubular sleeve 335. Wall 347 also depends from the upper cap panel 348 and is snugly insert into the upper, open end 349 of adapter sleeve 332. The interfit of closing cap walls 346 and 347 into the fitment 331 and adapter sleeve 332, respectively, closes off the flow passageways for products A and B.

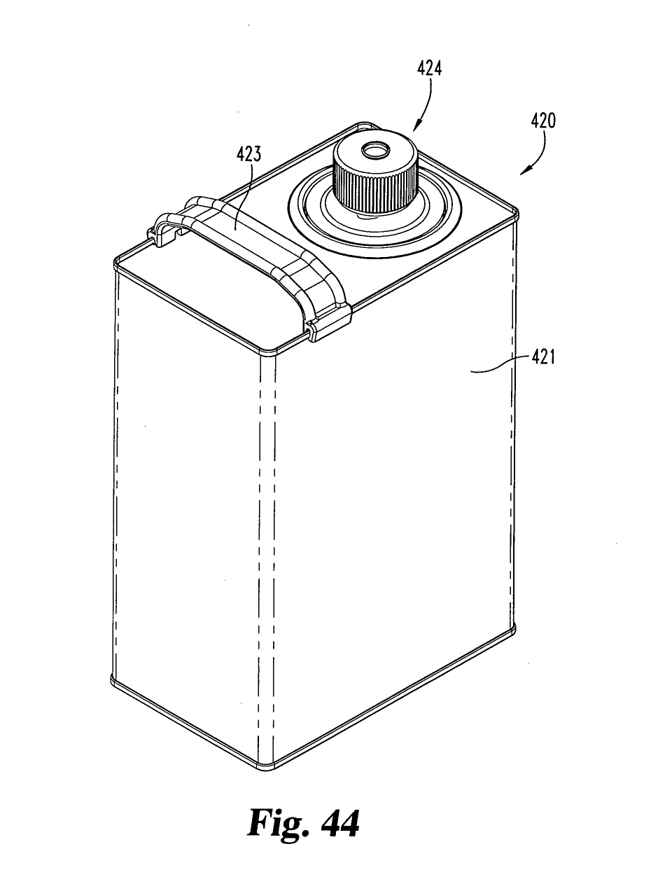

Referring now to FIGS. 44-54, another dispensing container embodiment of the present invention is illustrated. The construction of dispensing container assembly 420 is similar to dispensing containers 20, 120, 220, and 320 in terms of outer container 421 and handle 423. Inner container 422 is similar to the inner containers of the earlier embodiments in position and function relative to container 421. However, structurally, inner container 422 is a little different due in part to some of the design differences embodied within the dispensing closure 424.

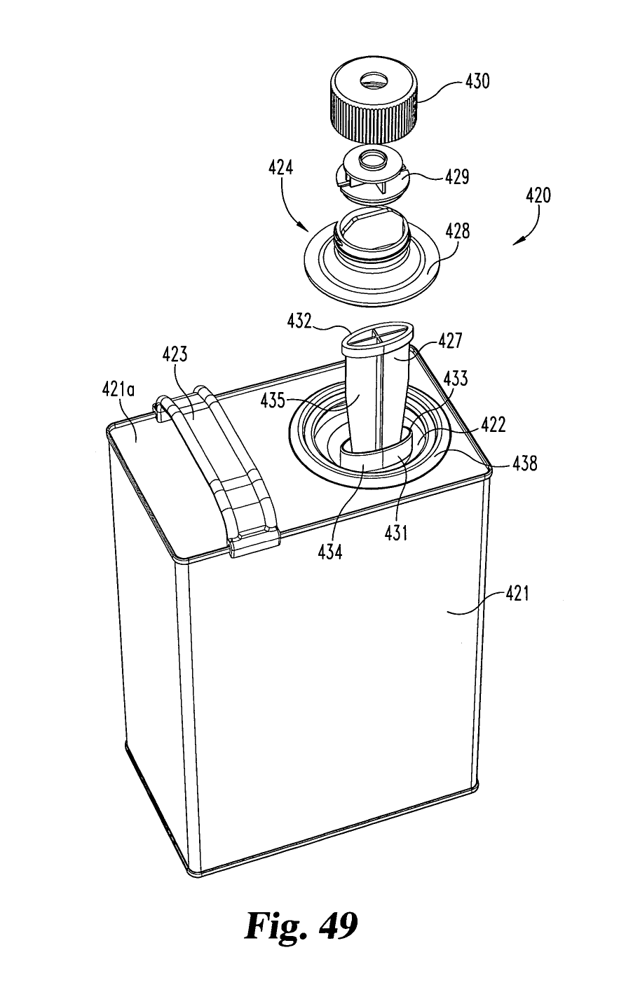

As detailed in FIG. 49, the component parts of dispensing closure 424 include insert paddle 427, fitment 428, closing plug 429, and closing cap 430. Each one of these four component parts is a unitary, molded plastic part. The inner container 422 includes a neck flange 431 that creates an open neck sleeve through which product B is dispensed. The oval head 432 of insert paddle 427 is seated on the upper surface 433 of neck sleeve 434. The body 435 of insert paddle 427 has a cruciform shape (i.e., four blades 90 degrees apart) and extends axially into the interior of inner container 422 in order to prevent container collapse that might choke off the dispensing flow of product B.

As depicted in FIGS. 44-54, inner container 422 is constructed and arranged as a flexible container as contrasted to a rigid container. The concept of a “flexible” container, as used in the descriptions of FIGS. 1-54, includes a plastic or synthetic material bag or pouch that is able to collapse inwardly as it empties as product is dispensed. The concept of a “flexible” container would also extend to a thin-walled, blow-molded container that is likely to collapse, at least to some degree, as it empties as product is dispensed. A “rigid” container, on the other hand, is one that is not likely to collapse as product is dispensed. This discussion is relevant in terms of whether or not insert paddle 427 is needed. The insert paddle 427 keeps at least one flow passageway open as the inner container 422 collapses. This ensures that the dispensing flow of product B will be able to continue until the inner container is empty, even if the container begins to collapse onto itself. If a “rigid” container is selected for inner container 422, then collapsing of that container will not be an issue and the insert paddle 427 is not needed.

Fitment 428 snaps into opening 438 formed into the upper panel 421 a of outer container 421 in a similar manner to what has already been described for the other embodiments. This snap-in configuration involves a depending annular lip formed in upper panel 421a and an annular recessed area as part of inner wall 439 bounded on the lower edge by an annular rib 440. Upper wall 441 is externally-threaded and threadedly mates with closing cap 430. Inner wall 442 is constructed and arranged to receive neck sleeve 434. Shelf 443 fits over a portion of oval head 432, thereby actually sandwiching the oval head 432 and thus the entire insert paddle 427 between shelf 443 and the upper surface 433 of the neck sleeve 434. Dividing wall 444 fits into the defined center slot 445 in closing plug 429. Dividing wall 444 functions to help separate products A and B as they are being dispensed so that these two products do not mix until actually dispensed into the receiving (mixing) receptacle.

The closing plug 429 is axially captured by the closing cap 430 and snugly fits into the upper open end 446 of fitment 428 through which products A and B are dispensed. While closing cap 429 snaps into the closing cap 430, the closing cap is able to turn/rotate relative to the closing plug. This means that as the closing cap is unscrewed from the fitment, the closing cap rotates relative to the closing plug and, at the same time as the closing cap moves axially, it pulls the closing plug in an axial direction so as to pull the closing plug out of sealing engagement with fitment opening 446.

The closing plug 429 includes an upper portion 447 that fits into the center opening 448 of the closing cap 430. The annular lip 449 provides one location of a snap-fit assembly. A second location is provided by flange 450 and the inner radial lip 451 of inner wall 452 of closing cap 430. These two snap-fit locations ensure that the closure plug and closing cap remain assembled to each other as an integral subassembly. The circular or annular nature of upper portion 447 and flange 450, as well as their size, allow the closing cap 430 to rotate relative to the closing plug 429.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A dispensing container assembly for two flowable products comprising:
a first container constructed and arranged for holding a volume of a first flowable product;
a second container constructed and arranged for holding a volume of a second flowable product, said second container being positioned inside of said first container;
a first dispensing closure assembled to said first container, said first dispensing closure including a first fitment, a first adapter sleeve assembled to said first fitment, a first dispensing spout positioned within said first fitment and a first closing cap assembled to said first adapter sleeve and being constructed and arranged relative to said first dispensing spout such that said first dispensing spout is axially extended by the removal of said first closing cap from said first adapter sleeve; and
a second dispensing closure assembled to said second container, said second dispensing closure including a second fitment, a second adapter sleeve assembled to said second fitment, a second dispensing spout positioned within said second fitment and a second closing cap assembled to said second adapter sleeve and being constructed and arranged relative to said second dispensing spout such that said second dispensing spout is axially extended by the removal of said second closing cap from said second adapter sleeve.

2. A dispensing container assembly for two flowable products comprising:
a first container constructed and arranged for holding a volume of a first flowable product;
a second container constructed and arranged for holding a volume of a second flowable product, said second container being positioned inside of said first container;
a first dispensing closure assembled to said first container, said first dispensing closure including a first fitment including a first dispensing spout, a first adapter sleeve assembled to said first fitment, and a first closing cap assembled to said first adapter sleeve; and
a second dispensing closure assembled to said second container, said second dispensing closure including a second fitment including a second dispensing spout, a second adapter sleeve assembled to said second fitment, and a second closing cap assembled to said second adapter sleeve.

3. A dispensing container assembly for two flowable products comprising:
a first container constructed and arranged for holding a volume of a first flowable product;
a second container constructed and arranged for holding a volume of a second flowable product, said second container being positioned inside of said first container;
a first dispensing closure assembled to said first container, said first dispensing closure including a first portion of a fitment, said first portion including a first dispensing spout, a first adapter sleeve assembled to said first portion of said fitment and a first closing cap assembled to said first adapter sleeve;
a second dispensing closure assembled to said second container, said second dispensing closure including a second portion of a fitment, said second portion including a second dispensing spout, a second adapter sleeve assembled to said second portion of said fitment and a second closing cap assembled to said second adapter sleeve.

4. A dispensing container assembly for two flowable products comprising:
a first container constructed and arranged for holding a volume of a first flowable product;
a second container constructed and arranged for holding a volume of a second flowable product, said second container being positioned inside of said first container;
a dispensing closure assembled into said first container and connected to said second container, said dispensing closure including a fitment, an adapter sleeve assembled to said fitment and a closing cap threadedly attached to said adapter sleeve, said fitment including an inner dispensing outlet constructed and arranged to receive product from said second container, said fitment further including an outer dispensing outlet separate from said inner dispensing outlet and being constructed and arranged to receive product from said first container;
a first vent tube connected to said fitment and extending into said first container; and
a second vent tube connected to said fitment and being constructed and arranged to communicate with said second container.

5. A dispensing container assembly for two flowable products comprising:
a first container constructed and arranged for holding a volume of a first flowable product;
a second container constructed and arranged for holding a volume of a second flowable product, said second container being positioned inside of said first container;
a dispensing closure assembled into said first container and connected to said second container, said dispensing closure including a fitment, a closing plug constructed and arranged to close off said fitment, a closing cap threadedly attached to said adapter sleeve and being constructed and arranged to capture said closing plug such that said closing plug moves axially with said closing cap and an insert paddle having one portion extending into said second container and another portion positioned between said second container and said fitment.
